(19) United States
(12) Patent Application Publication
(10) Pub. No.: US 2010/0145803 A1
(43) Pub. Date: Jun. 10, 2010

(54) METHOD FOR CONTEXTUAL BASED CLASSIFIED ADVERTISING

(76) Inventor: Ofir Kobani, Moshav Ganei Yohanan (IL)

Correspondence Address: The Law Office of Michael E. Kondoudis, 888 16th Street, N.W., Suite 800, Washington, DC, 20006, US

(21) Appl. No.: 12/375,030

(22) PCT Filed: Jul. 24, 2007
(86) PCT No.: PCT/IL2007/000933

§ 371 Date: Dec. 6, 2009

Related U.S. Application Data
(60) Provisional application No. 60/832,611, filed on Jul. 24, 2006.

(51) Int. Cl. G06Q 30/00

(52) U.S. Cl. 705/14.52; 705/14.49

(57) ABSTRACT

The present invention is designed to supply an automated solution for the publishing of one or more ads in multiple pages of websites. Embodiments of the present invention enable website owners to automatically present commercial advertisements on their websites while ensuring that the content of the automatically selected ads does not conflict with the content of the website. According to embodiments of the present invention the proposed system and method enables the classifying of one or more ads and website pages, according to predefined categories and key words. Thus, website owners and advertisers can optionally define their own categories as well as the categories to which they wish to be associated with.

### FIELD OF INVENTION

The present invention relates to systems and methods for managing the distribution of advertisements in websites, more particularly the present invention relates to systems and method for classifying the desirable advertisements on websites.

### BACKGROUND OF THE PRIOR ART

Embedding commercial advertisements in websites is one of the most accessible and common ways for making websites economically viable while not charging users with user fees. Automatic selection of advertisements was found to enable website owners to reach a larger range of advertisers without having to individually connect each one. Moreover, it was found to be beneficial to customize the types of ads presented in a particular website to the content of the website and to the type of users who view it. Accordingly, known in the art are many solutions for associating the type of ads selected for a website with the content of the website.

Existing solutions rely on thematic association between the content of the website and the content of the ads, such as through automatically associating between keywords. However, these solutions do not take into account the fact that conflicting interests might come up between the content of the website and the content of the ads. For instance, ads shown in a website which promotes a product of a particular company might promote the same product of a competing company. There is therefore a need for a system and a method which would allow website owners to define the categories of ads which they wish to present on their websites. Such a solution would enable website owners to present ads on their websites which might be relevant for their users while ensuring that these ads do not compete with the services and products they wish to promote.

### SUMMARY OF INVENTION

Disclosed is a method for automatically allocating advertisements to web pages. The method includes the steps of defining a plurality of categories, associating web pages to categories and associating advertisements to categories. The method also includes the steps of defining the desirable advertisement categories for the web pages, defining desirable web page categories for the advertisements, and automatically matching advertisements to web pages in accordance with the categories.

The matching of advertisements to web pages may include the step of associating them in accordance with correlations between the advertisement categories and the specified desirable advertisements of the web page. Similarly, the matching of advertisements to web pages may include the step of associating them in accordance with correlations between the web page categories and the specified desirable web page of the advertisement. Finally, the matching may be performed in accordance with cross correlations between the advertisement categories and the specified desirable advertisements of the web pages and the web page categories and the specified desirable web pages of the advertisements.

The categories may be classifications or key words. The classifications may be organized in a structured hierarchy. The types of the classifications may include geographic location, service type, product type, content type and customer type. The method may further include the step of gathering statistic information concerning the appearances of the ads in the web pages and of gathering statistic information concerning web page user behavior in the web pages. The method may further include the step of collecting billing information wherein the billing information is collected according to a predefined billing scheme. The billing scheme may operate in accordance with the number of times the advertisement is viewed in the web page, the number of times the advertisement is selected by users of the web page, or amount of exposure time of the advertisement in the web page.

The method may further include the step of enabling advertisers define advertisement presentation features. The features may include advertisement size, advertisement appearance, and advertisement location on the web page. The method may further include the steps of collecting popularity indications of the categories and of presenting them to advertisers and web pages owners.

Also disclosed is a web-based system for automatically allocating advertisements to web pages. The system comprises an interface for defining a plurality of categories, an interface for enabling the association of web pages to categories and an interface for enabling the association of advertisements to categories. The system also comprises an interface for defining for the web pages desirable advertisement categories, an interface for defining for the advertisements desirable web page categories, and a module for automatically matching advertisements to web pages in accordance with the categories.

The module may enable associating advertisements to web pages in accordance with correlations between the advertisement categories and the specified desirable advertisement of the web pages. Similarly, the module may enable associating advertisements to web pages in accordance with correlations between the web pages categories and the specified desirable web page of the advertisements. Finally, the module may perform the matching in accordance with cross correlations between the advertisement category and the specified desirable advertisement of the web page and the web page category and the specified desirable web page of the advertisement.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a flowchart depicting the general functionality of embodiments of the present invention;

FIG. 2 is a schematic illustration of a flowchart of the main system functionality as it is performed by the main process advertisement manager in accordance with embodiments of the present invention;

FIG. 3 is a schematic illustration of a flowchart of a more detailed description of the ad and web page classification process in accordance with embodiments of the present invention;

FIG. 4 is a flow diagram of the advertisement definition process

FIG. 5 is a flow diagram of the advertising process.

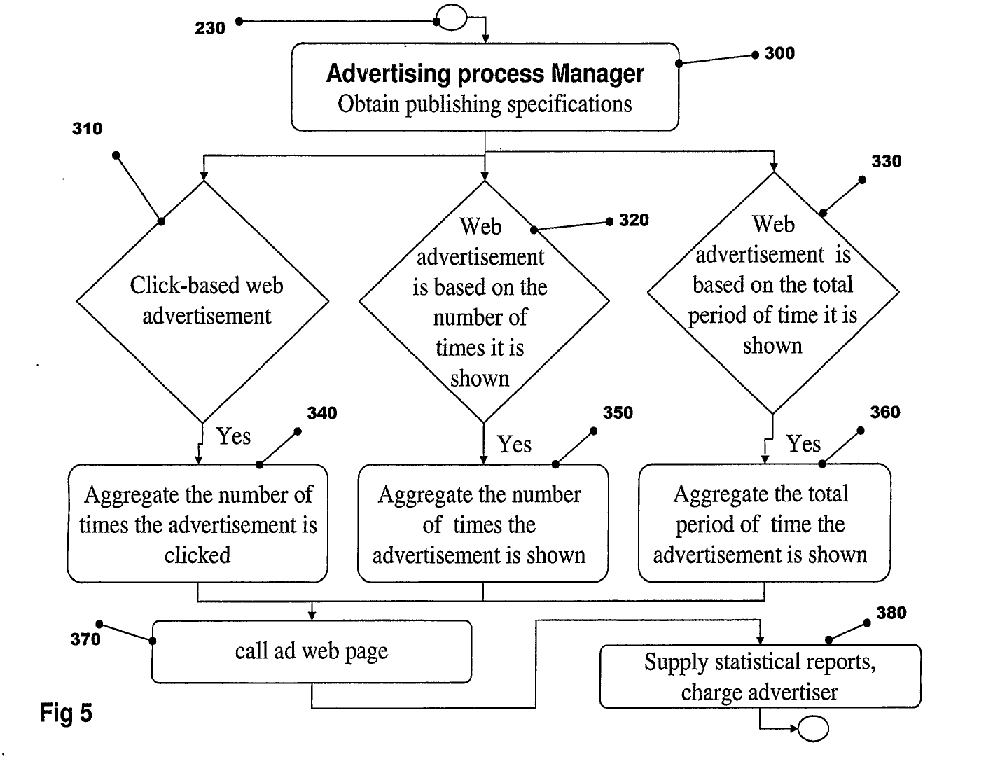

FIG. 6 is a flow diagram of an example for the creating and publishing advertisement process.

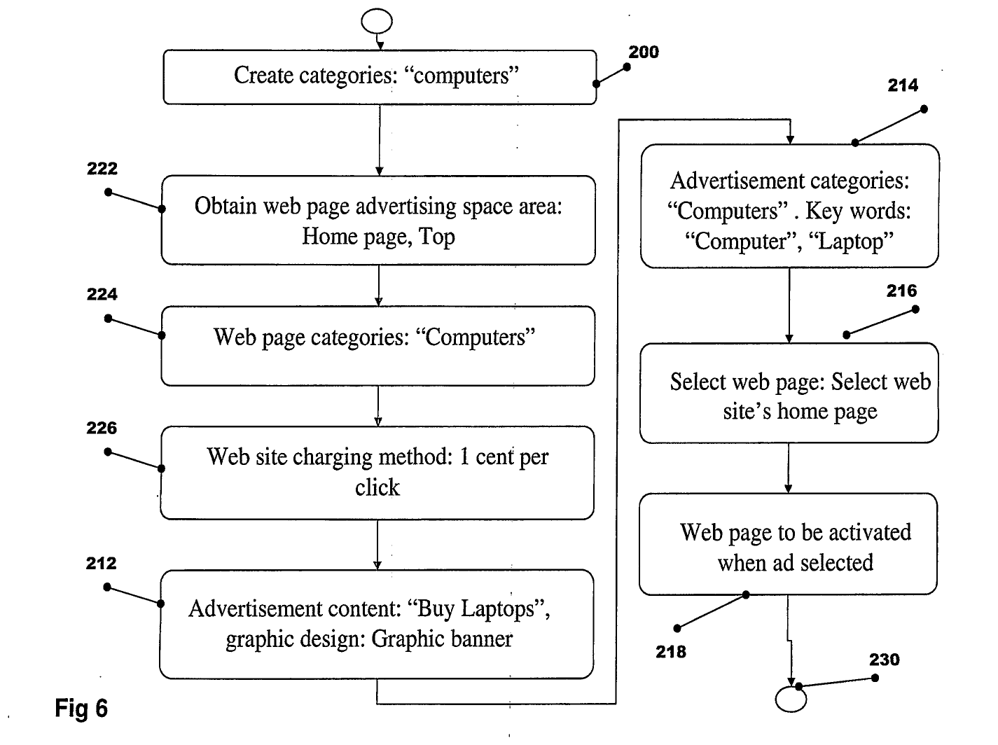

FIG. 7 is a flow diagram of an example for the advertising process.

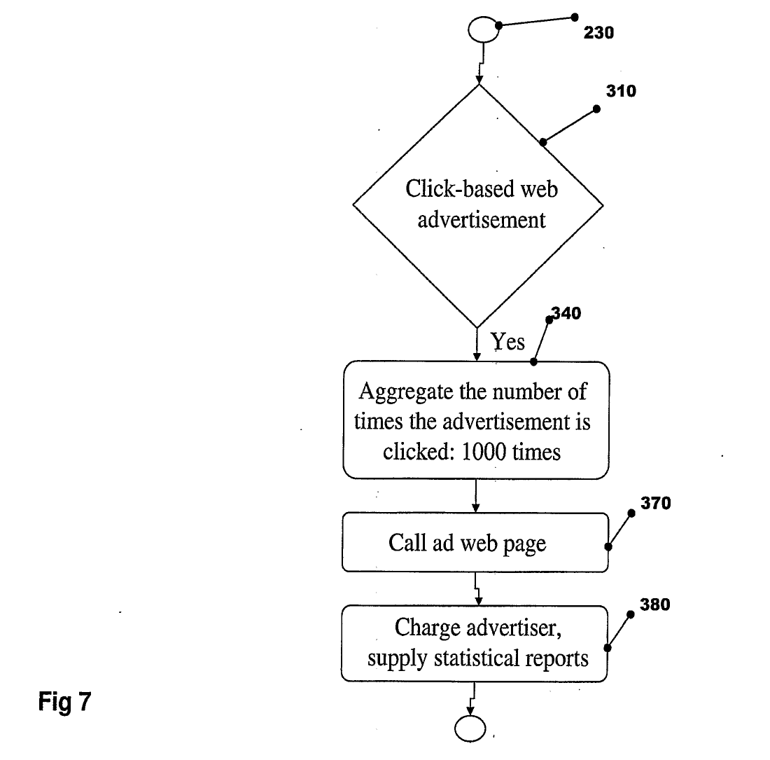

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The present invention is designed to supply an automated solution for the publishing of one or more ads in multiple pages of websites. Embodiments of the present invention enable website owners to automatically present commercial advertisements on their websites while ensuring that the content of the automatically selected ads does not conflict with the content of the website. According to embodiments of the present invention the proposed system and method enables the classifying of one or more ads and website pages, according to predefined categories and key words. Thus, website owners and advertisers can optionally define their own categories as well as the categories to which they wish to be associated with. For instance, advertisers of restaurants can define that they wish to present their ads in recreational websites which do not include restaurants, and likewise website owners of websites promoting restaurants can define that they wish to present advertisements on their websites that might be relevant for their users but do not include ads for other restaurants.

Categories can be organized under a structured hierarchy enabling an improved and more accurate ad and web page classification. One advantage of the present invention is that it enables a context-based ad targeting. Embodiments of the present invention also enable designing graphic based ads using an advertising graphic tool. The graphic tool enables the reuse of existing graphic objects in graphical based advertisements, thereby reducing costs and making advertisement for small businesses feasible. Embodiments of the present invention also enable geographic targeting of advertisements, thereby allowing web users to view commercials relevant to their geographic location. The geographic targeting is based on the classification of websites and ads using predefined categories. The owner of the system may define geographic location categories and then classify ads and web pages accordingly.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figure and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

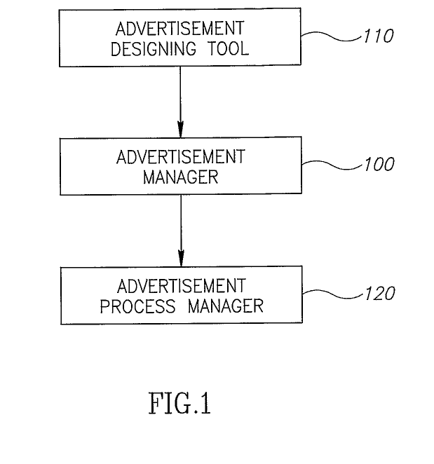

A general description of the present invention is illustrated in the flowchart of FIG. 1. The advertisement manager main process (100) enables the classification of one or more ads and the classification of multiple web pages according to predefined categories. Furthermore, it enables matching of one or more ads to specific web pages. New ads may be designed using an advertisement designing tool (110). Once the ad is published, the system aggregates the total amount of time it was viewed and the number of times it was clicked, using an advertising process manager (120).

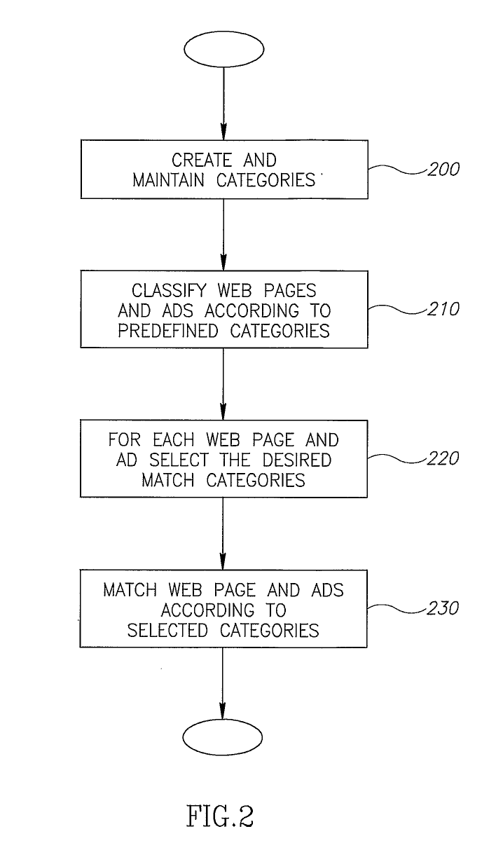

FIG. 2 illustrates a flowchart of the main system functionality as it is performed by the main process advertisement manager (100). The system enables the classification of ads and web pages according to one or more categories. First, categories may be defined and maintained (200). Categories may optionally describe a variety of fields and classifications. A category could, for example, describe: a geographic location or direction such as “north”, “south”, city names, zip code areas, city area phone code, etc; a trade classification, such as “wholesaler”, “retailer”, “service provider”; a trade subject, such as “Computers”, “Food and beverage”, “Health products”, and the like. Categories can also be organized under a structured hierarchy, thereby allowing the assigning of multiple subcategories under a mutual parent category. Such hierarchy enables an improved and more accurate ad and web page classification. Furthermore, ads and website selection may optionally be performed according to their subcategory or according to any of their parent categories in their category hierarchy. For example, an ad for a laptop computer may be classified under the parent category of “electronic appliances”, category “computer” and subcategory “laptops”. The ad for the laptop would be presented on websites which select any of the categories in its hierarchy: “electronic appliances”, “computer” or “laptops”.

Once categories are defined, the system enables classifying the web pages and ads according to the categories (210). Each web page and ad may optionally be classified to one or more categories. Next, the owners of the web pages and ads select the categories of their desired matches. For instance, an advertiser of a rent-a-car business may wish to display his or her ads in web pages which are categorized as belonging to businesses in the same geographic location which are categorized in related business categories, such as hotels, restaurants, tourist attractions and the like, but not in web pages which are categorized as rent-a-car businesses. Finally, the system automatically creates matches between ads and web pages according to the data entered by the users in the previous steps (230).

According to some embodiments of the present invention the system may also enable advertisers to define their preferences for presenting their ads in web pages. For instance, advertisers may define the size of the ads, their location on the web page, their shape and the like.

According to some embodiments of the present invention the system also monitors each of the web pages and gathers statistic information concerning the appearance of each of the ads in the web pages. Advertisers can then see where and when their ads where presented, for how long, and receive additional information about the characteristics of the people viewing their ads. For instance, the system can collect information concerning the behavior of the viewers, such as average duration of time viewers spend on the web pages which presented the ads of the advertiser, the type of links they clicked on, and the like. Advertisers may then analyze this information to understand whether the current categorization of their advertisements is beneficial for them, and adjust the attributes of their ads accordingly. Similarly, owners of web pages can receive information concerning the types of ads presented on their web pages and adjust their category definitions accordingly.

According to some embodiments of the present invention the system is also comprised of a billing mechanism. The system collects information concerning the displaying of each ad on each of the web pages and extracts the relevant information according to the defined billing scheme. The charging method could, for example, be determined by the number of times a customer clicked on the ad, the number of times the ad is shown, the duration of time in which the ad was presented and so on.

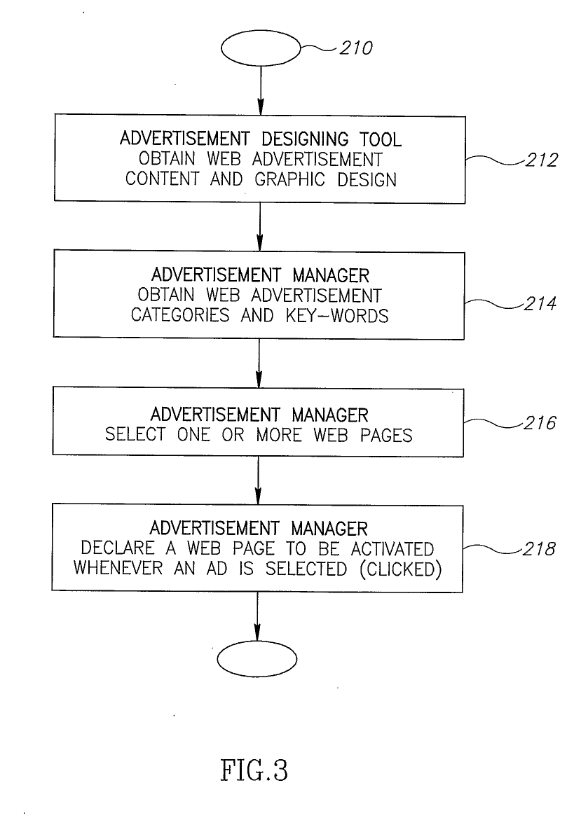

A more detailed description of the ad and web page classification process is illustrated in FIG. 3. The system enables creating and designing multiple graphic and textual ads, using the advertisement designing tool (212). The advertisement designing tool enables an intuitive method to rapidly design and edit graphical and textual-based ads, using existing graphical tools and graphic designs. Once the ad is properly designed, the classifying categories are obtained (214). The system enables classifying the ad using multiple categories, thereby allowing the setting of predefined contextual meanings. Furthermore, classifying ad using the categories enables the selection of one or more classified web pages, sharing the same categories or sharing mutual parent category (216). Each of the classified websites provided, presents the preferred charging method and prices, thereby, enabling the advertiser to select the preferred websites, according to his budget and needs. Furthermore, the system enables presenting detailed statistical information regarding website and web page popularity, thereby allowing the advertiser to select advertising pages accordingly to gain maximum ad exposure. Furthermore, the system enables presenting detailed statistical information regarding the popularity of classifying categories, thereby improving ad classifying process and allowing ads classified under the most popular categories a maximum exposure. The selected web pages will advertise the ad according to the web page predefined terms and charging methods. Moreover, an additional way to classify ads is provided. The system enables the advertiser to create a list of multiple key-words. These key-words enable the advertising web-page to select and present the ad, whenever the keyword is manually searched in the hosting website. Usually, an advertiser would be interested in calling his own web page whenever an ad is selected by the user. The system enables selecting such website address and activating it whenever the ad is clicked (218).

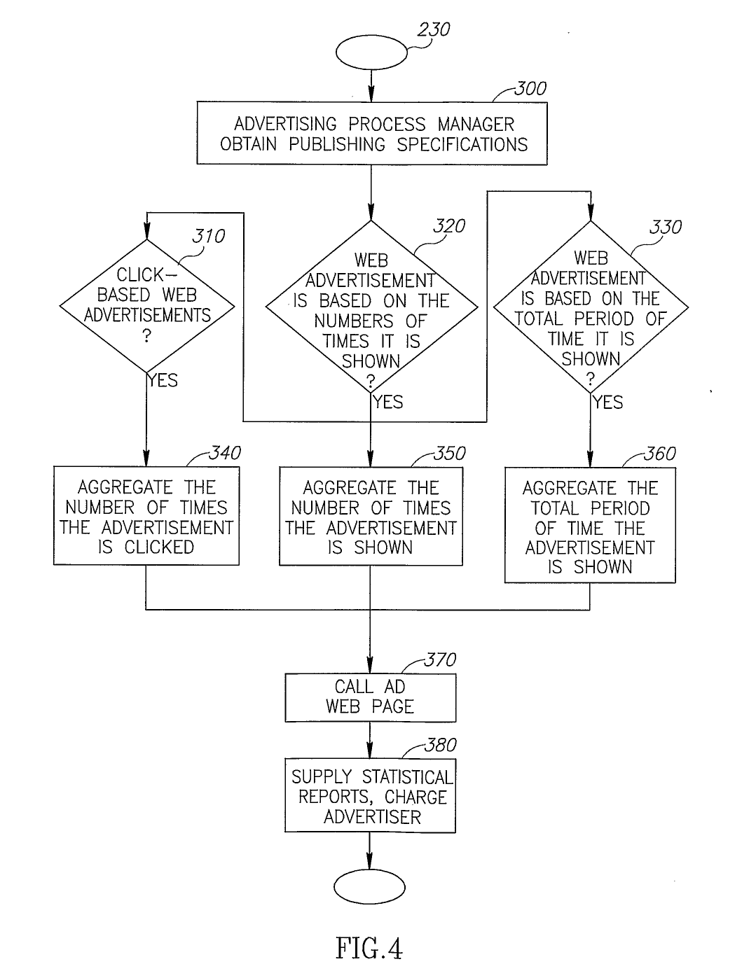

A more detailed description of the advertising process is illustrated in FIG. 4. Once the ad is published within the selected web pages, it may be presented upon a page activation. The charging of the advertiser, could then take place, using a number of methods. FIG. 4 illustrates an example for three different charging methods: charging an advertiser for the number of times a specific ad has been selected (clicked) (310); charging an advertiser for the number of times the ad has been shown (320); charging the advertiser for the total duration of time the ad has been shown (330). Nevertheless, other suitable methods could be used for the same purpose. The charging methods are declared during the web-page classification process. If a click-based charging method is selected (310), the system aggregates this selection including the time and date, and other web page identifications (340). Alternatively, the system aggregates the number of times the ad has been shown (350) if the relevant charging method is selected (320). The third optional charging method enables the system to aggregate the total duration of time in which the ad has been shown (360) if the relevant charging method is selected (330). The system enables opening a web page whenever the ad is selected (clicked). If such a web page was declared, the system will open a new window and the web page will be activated (370). Furthermore, the system enables storing and processing this information, and automatically producing statistical reports and generating debit and credit notes for both the advertisers and the advertising web owners (380).

Users of the system access the system via web interface using any type of end station or terminal. Such end stations or terminal, can optionally be embodied, without limitations, by a cellular telephone, by a wireless telephone, by a Personal Communication Systems (PCS) device, by a PDA device that incorporates a wireless communication device, by a tablet computer, by a server computer, by a personal computer, by a wireless communication station, by a mobile computer, by a notebook computer, by a desktop computer, by a laptop computer a Personal Digital Assistant (PDA) device, by a landline phone, a pager, by server (e.g., SMS server, MMS server, internet server) and the like.

A processor can optionally be embodied, without limitations, by a chip, by a microprocessor, by a controller, by a Central Processing Unit (CPU), by a Digital Signal Processor (DSP), by a microchip, by an Integrated Circuit (IC), or any other suitable multi-purpose or specific processor or controller.

It should be understood that some embodiments of the invention can optionally be implemented, for example, using a machine-readable medium or article which can optionally store an instruction or a set of instructions that, if executed by a machine, cause the machine to perform a method or operations or both in accordance with embodiments of the invention. Such a machine can optionally include, for example, any suitable processing platform, computing platform, computing device, processing device, computing system, processing system, computer, processor, or the like, and can optionally be implemented using any suitable combination of hardware or software or both. The machine-readable medium or article can optionally include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a rewritable DVD, a tape, a cassette, or the like. The instructions can optionally include any suitable type of code, for example, an executable code, a compiled code, a dynamic code, a static code, interpreted code, a source code or the like, and can optionally be implemented using any suitable high-level, low-level, object-oriented, visual, compiled or interpreted programming language. Such a compiled or interpreted programming language can optionally be, for example, C, C++, C#, .Net, Java, Pascal, MATLAB, BASIC, Cobol, Fortran, assembly language, machine code and the like.

It should be noted that embodiments of the invention can optionally be used in a variety of applications. Examples of embodiments of the invention can optionally include the usage of the invention in conjunction with many networks. Examples of such networks can optionally include, without limitation, a wide area network (WAN), local area network (LAN), a global communication network, e.g., the Internet, a wireless communication network such as, for example, a wireless LAN (WLAN) communication network, a wireless virtual private network (VPN), a Bluetooth network, a cellular communication network, for example, a 3^{rd} Generation Partnership Project (3GPP), such as, for example, a Global System for Mobile communications (GSM) network, a Code Division Multiple Access (CDMA) communication network, a Wideband CDMA communication network, a Frequency Domain Duplexing (FDD) network, and the like.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for automatically allocating advertisements to web pages, said method comprising the steps of:
defining a plurality of categories;
associating at least one web page to at least one category;
associating at least one advertisement to at least one category;
defining for said web page at least one desirable advertisement category;
defining for said advertisement at least one desirable web page category; and
automatically matching at least one advertisement to at least one web page in accordance with said categories.

2. The method of claim 1 wherein said matching associates at least one advertisement to at least one web page in accordance with correlations between said advertisement category and said specified desirable advertisement of said web page.

3. The method of claim 1 wherein said matching associates at least one advertisement to at least one web page in accordance with correlations between said web page category and said specified desirable web page of said advertisement.

4. The method of claim 1 wherein said matching is performed in accordance with cross correlations between said advertisement category and said specified desirable advertisement of said web page and said web page category and said specified desirable web page of said advertisement.

5. The method of claim 1 wherein said categories are at least one of the following: classifications; key words.

6. The method of claim 5 wherein said classifications are organized in a structured hierarchy.

7. The method of claim 5 wherein the types of said classifications are at least one of the following: a geographic location; a service type; a product type; content type; customer type.

8. The method of claim 1 further including the step of gathering statistic information concerning the appearances of said ads in said web pages.

9. The method of claim 8 further including the step of gathering statistic information concerning web page user behavior in said web pages.

10. The method of claim 1 further including the step of collecting billing information wherein said billing information is collected according to a predefined billing scheme.

11. The method of claim 10 wherein said billing scheme operates in accordance with at least one of the following: number of times said advertisement is viewed in said web page; number of times said advertisement is selected by users of said web page; amount of exposure time of said advertisement in said web page.

12. The method of claim 1 further including the step of enabling advertisers define advertisement presentation features.

13. The method of claim 12 wherein said features include at least one of the following: advertisement size, advertisement appearance, advertisement location on said web page.

14. The method of claim 1 further including the steps of:
collecting popularity indications of said categories;
presenting advertisers and web pages owners said popularity indications of said categories.

15. A web-based system for automatically allocating advertisements to web pages, said system comprising:
an interface for defining a plurality of categories;
an interface for enabling the association of at least one web page to at least one category;
an interface for enabling the association at least one advertisement to at least one category;
an interface for defining for said web page at least one desirable advertisement category;
an interface for defining for said advertisement at least one desirable web page category; and
a module for automatically matching at least one advertisement to at least one web page in accordance with said categories.

16. The system of claim 15 wherein said module enables associating at least one advertisement to at least one web page in accordance with correlations between said advertisement category and said specified desirable advertisement of said web page.

17. The system of claim 15 wherein said module enables associating at least one advertisement to at least one web page in accordance with correlations between said web page category and said specified desirable web page of said advertisement.

18. The system of claim 15 wherein said module performs said matching in accordance with cross correlations between said advertisement category and said specified desirable advertisement of said web page and said web page category and said specified desirable web page of said advertisement.

19. The system of claim 15 wherein said categories are at least one of the following: classifications; key words.

20. The system of claim 19 wherein said classifications are organized in a structured hierarchy.

21. The system of claim 19 wherein the types of said classifications are at least one of the following: a geographic location; a service type; a product type; content type; customer type.

22. The system of claim 15 further enabling the gathering statistic information concerning the appearances of said ads in said web pages.

23. The system claim 15 further enabling the gathering statistic information concerning web page user behavior in said web pages.

24. The system of claim 15 further enabling the collection of billing information wherein said billing information is collected according to a predefined billing scheme.

25. The system of claim 24 wherein said billing scheme operates in accordance with at least one of the following: number of times said advertisement is viewed in said web page; number of times said advertisement is selected by users of said web page; amount of exposure time of said advertisement in said web page.

26. The system of claim 15 further enabling advertisers define advertisement presentation features.

27. The system of claim 26 wherein said features include at least one of the following: advertisement size, advertisement appearance, advertisement location on said web page.

28. The system of claim 15 further enabling the collecting popularity indications of said categories and presenting said popularity indications of said categories to advertisers and web pages owners.
